(19) United States
(12) Patent Application Publication
(10) Pub. No.: US 2024/0360928 A1
(43) Pub. Date: Oct. 31, 2024

(54) COUPLER USABLE IN A GEOTHERMAL SYSTEM

(71) Applicant: Geovention, Inc., Ames, IA (US)

(72) Inventor: Steve Kapaun, Ames, IA (US)

(21) Appl. No.: 18/647,901

(22) Filed: Apr. 26, 2024

Related U.S. Application Data
(60) Provisional application No. 63/499,057, filed on Apr. 28, 2023.

(51) Int. Cl. F16L 25/00

(52) U.S. Cl. CPC F16L 25/0045

(57) ABSTRACT

Disclosed is a system comprising a body having a first mating surface, a first piping extending through the body and having a second mating surface facing the first mating surface, a retaining collar around the body, a second piping having an end between the retaining collar and the body, and at least one seal between the first piping and the second piping to create a watertight seal.

### CROSS-REFERENCE TO RELATED APPLICATIONS

This application claims the benefit of U.S. Provisional Patent Application No. 63/499,057 filed with the United States Patent and Trademark Office on Apr. 28, 2023 the entire contents of which is herein incorporated by reference.

### BACKGROUND

### 1. Field

Example embodiments relate to a link or coupler. More specifically, example embodiments relate to a link or coupler to connect geothermal tubing (or piping).

### 2. Description of the Related Art

Geothermal systems are known in the art. Conventionally, geothermal systems contain one or more loops formed by tubing of different materials, e.g., cylindrical tubing, commonly made of high-density polyethylene (HDPE), polyethylene material (PEX), or the like, and corrugated tubing, commonly made of stainless steel. Various approaches exist to connect these tubing of different materials.

In some instances, the tubing is connected through “hot work”, which can involve brazing, welding such as fusion welding, and soldering, etc., or through “wet work”, which involves using mastics, adhesives, epoxies, etc. Each of these approaches has deficiencies. Hot work is time-consuming, expensive, and subject to leaking. Wet work is also time-consuming and subject to leaking, as well as being difficult to work with due to the inherent messiness present when adhesives and the like are used.

One alternative is to connect the tubing through mechanical measures, such as screwing. This approach creates the problem of providing an inferior seal that is prone to leaking. Additionally, the repeated heating and cooling the tubing undergoes leads to “unscrewing” whereby the mechanical connection becomes undone or loosens.

Leakage of any kind is a substantial problem. Antifreeze used in geothermal systems can cause environmental harm and is also costly to replenish. The cost is not limited to antifreeze as any other liquid used in the system must be replaced upon leakage.

Thus it is a primary aspect of this disclosure to provide a coupler usable in a geothermal system that improves upon the art.

These and other aspects, features, and advantages of the invention will become apparent from the specification and claims.

### SUMMARY

Disclosed is a coupler comprised of a body having a first end and a second end, a flange arranged at the first end of the body, and an engagement rib between the first end and the second end, wherein an inside surface of the body has a mating pattern configured to mate with a complementary mating pattern of a first piping.

Disclosed is a system comprising a body having a first mating surface, a first piping extending through the body and having a second mating surface facing the first mating surface, a retaining collar around the body, a second piping having an end between the retaining collar and the body, and at least one seal between the first piping and the second piping to create a water tight seal.

### BRIEF DESCRIPTION OF THE DRAWINGS

Example embodiments are described in detail below with reference to the attached drawing figures, wherein:

FIG. 1 is a view of a coupler in accordance with example embodiments;

FIG. 2 is an exploded view of the coupler in accordance with example embodiments;

FIG. 3 is a cross-section of the coupler in accordance with example embodiments;

FIG. 4 is a view of a first half of a body in accordance with example embodiments; and

FIG. 5 is a view of a second half of a body in accordance with example embodiments.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to a link or coupler to connect geothermal tubing (or piping).

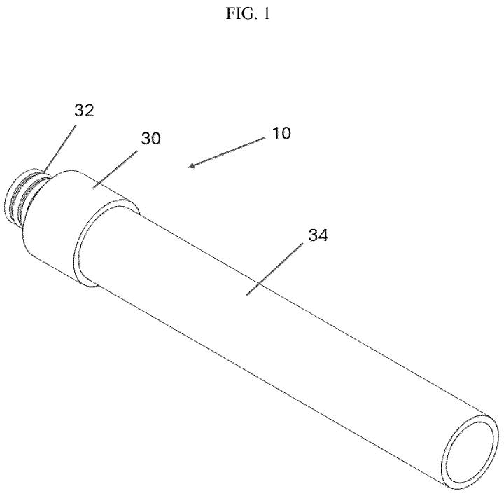

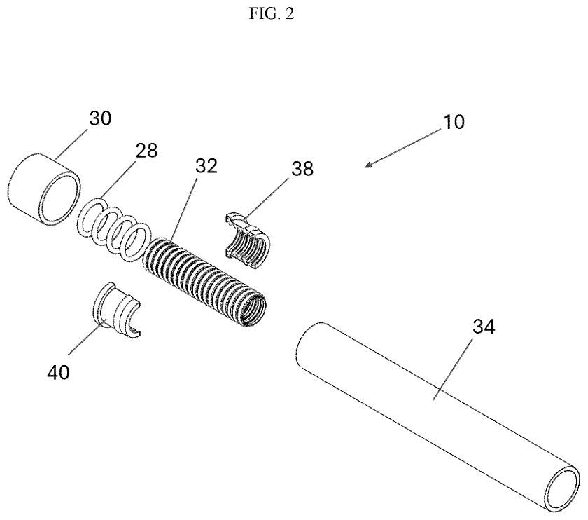

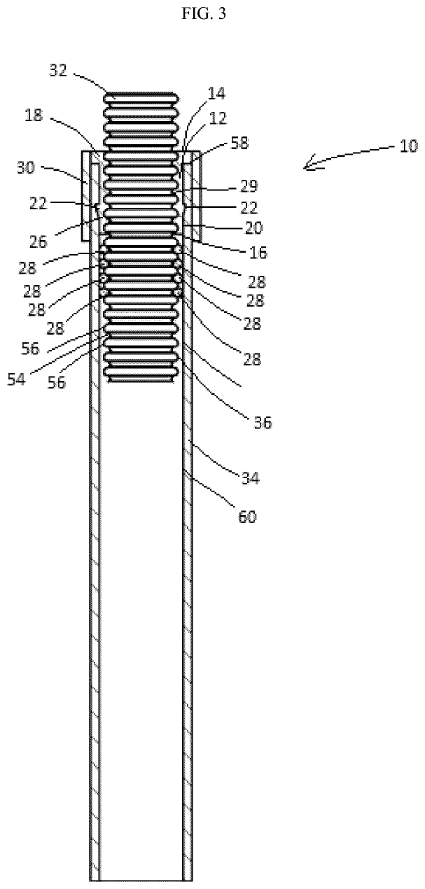

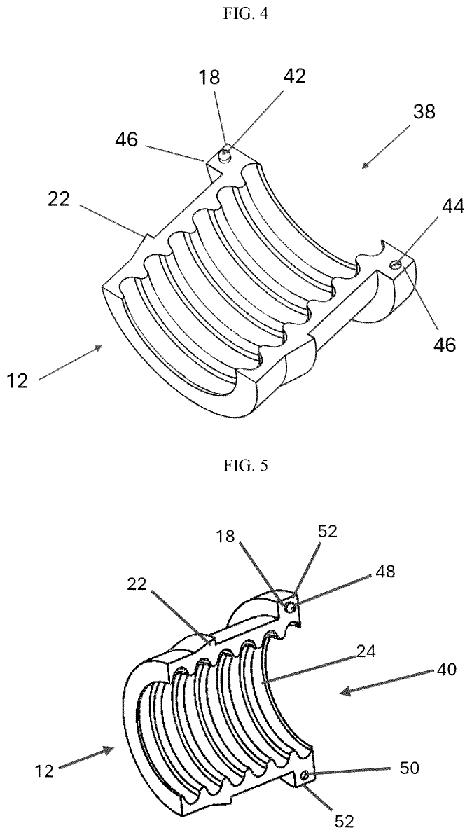

FIG. 1 is a perspective view of a coupler 10 in accordance with a nonlimiting example embodiment. FIG. 2 illustrates an exploded view of the coupler 10. FIG. 3 is a cross-section view of the coupler 10. In FIGS. 1-3, the coupler 10 is coupling together a first piping 32 and a second piping 34. In example embodiments the coupler 10 may be used in a geothermal system. Thus, the coupler 10 may be construed as a geothermal coupler and described hereinafter as a geothermal coupler. However, this is not intended to limit the invention as the coupler 10 may be used in systems other than geothermal systems and thus may be construed as something other than a geothermal coupler. In other words, describing the coupler 10 as a geothermal coupler is not intended to limit the invention as the inventive concepts cover coupling members together regardless as to whether they are affiliated with a geothermal system or not.

In the exemplary embodiment of FIGS. 1-3, the coupler 10 is shown as including a body 12 extending from a first end 14 to a second end 16. The coupler 10 may further include a stop flange 18 positioned on an exterior 20 of the body 12 adjacent or abutting the first end 14. The coupler 10 may also include an engagement rib 22 positioned between the stop flange 18 and the second end 16. In some embodiments, the body 12, the stop flange 18, and the engagement rib 22 may be separately formed and then combined to together to form a substantially unitary structure. In another embodiment, the body 12, the stop flange 18, and the engagement rib 22 may be formed together as through a casting or printing process to create a unitary structure. Regardless, the coupler 10 may be formed with a mating pattern 24 formed along an interior 26 of the body 12 (and, in at least one embodiment, an interior of the stop flange 18). As will be explained, this mating pattern 24 may complement undulations (peaks and valleys formed by ribs and recesses) of a corrugated pipe (for example, when the first piping 32 is a corrugated stainless steel pipe). In this example, the undulations of the corrugated pipe may act as a second mating pattern which may complement the mating pattern 24. In example embodiments, the coupler 10 may further include one or more seals 28 which, in one embodiment, may be an o-ring. In addition to the aforementioned elements, the coupler 10 may further include a retaining collar 30. In example embodiments, the coupler 10 may be used to connect a first piping 32 to a second piping 34, which in some embodiments the first piping 32 and the second piping 34 are formed of dissimilar material. For example, in some embodiments, the first piping 32 is a corrugated stainless steel tubing and/or the second piping 34 is a cylindrical PEX tubing. These materials, of course, are for exemplary purposes rather and should not be construed as limiting the invention.

In example embodiments, the stop flange 18 may have an exterior diameter that is larger than the exterior diameter of a remainder of the body 12. In at least one example embodiment, the engagement rib 22 resembles one or more protrusions having a triangular profile along a cross-section of the engagement rib 22 which may be formed by the engagement rib 22 extending outwardly from the exterior 20 at an angle towards the first end 14. In certain aspects, the engagement rib 22 has a right triangular profile. In still other aspects, the mating pattern 24 is formed to matingly engage a ribbing 36 of the first piping 32. In yet other aspects, the retaining collar 30 has an interior diameter that is larger than an exterior diameter of the second piping 34.

In some example embodiments, the body 12 is split into a first member 38 and a second member 40 that align to form the body 12. In some embodiments, the first member 38 has a first protuberance 42 and a first indentation 44 which may be positioned on a first set of opposing ends 46 of the stop flange 18 such that when the first member 38 is aligned with the second member 40 the first protuberance 42 extends outwardly from the first member 38 towards the second member 40. In still other aspects, the second member 40 has a second protuberance 48 and a second indentation 50 where the second protuberance 48 and the second indentation 50 are positioned on a second set of opposing ends 52 of the stop flange 18 such that when the first member 38 is aligned with the second member, the first protuberance 42 is received within the second indentation 50 and the second protuberance 48 is received in the first indentation 44.

In other aspects, the seal 28 is positioned around the first piping 32, which in certain aspects is within a recess 54 formed between a set of ribs 56 of the ribbing 36. The first member 38 and the second member 40 are connected around the first piping 32. In some such aspects, the mating pattern 24 is formed to matingly engage the ribbing 36 of the first piping 32.

In still other aspects, the first piping 32 is inserted into the second piping 34 until the stop flange 18 engages an end 58 of the second piping 34. In this way, the stop flange 18 prevents the first piping 32 from being inserted further into the second piping 34. During and after insertion, the engagement rib 22 and/or the seal 28 engages an interior 60 of the second piping 34.

In some such aspects, the triangular profile of the engagement rib 22 facilitates insertion of the first piping 32 while resisting withdrawal of the first piping 32. In still other such aspects, the seal 28 occupies an empty space between the first piping 32 and the second piping 34 such that the seal engages the recess 54 of the first piping 32 and the interior 60 of the second piping 34 thereby creating a watertight seal that prevents withdrawal of the first piping 32 from the second piping 34. The retaining collar 30, in other aspects, is positioned around the second piping 34 and the stop flange 18, which in some aspects further prevents contaminant entry and/or leakage. In some such aspects, the retaining collar 30 provides a compressive force on the second piping 34 such that second piping 34 is compressed against the engagement rib 22 and/or 20 the seal 28. In this case, the collar 30 may be fabricated from a resilient material, for example, PEX, which may be mechanically expanded and slipped over the assembly. The collar 30 may be mechanically expanded using a conventional swaging tool. Once over the assembly collar 30 may return to its original inner diameter thus locking the assembly. In yet other aspects, the end 58 of the second piping 34 is swaged to increase the interior diameter of the second piping 34 along the length of the second piping 34 that receives the first piping 32 and the coupler 10.

Therefore, a coupler 10 has been provided that improves upon the art by providing a mechanical connection, without hot work or wet work, of two separate piping thereby preventing separation and leakage that is further enhanced by providing a watertight seal.

From the above discussion and accompanying figures and claims it will be appreciated that the coupler 10 offers many advantages over the prior art.

Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What I claim is:

1. A coupler comprising:
a body having a first end and a second end;
a flange arranged at the first end of the body; and
an engagement rib between the first end and the second end, wherein an inside surface of the body has a mating pattern configured to mate with a complementary mating pattern of a first piping.

2. The coupler of claim 1, wherein a cross section of the engagement rib is a triangle.

3. The coupler of claim 1, wherein the triangle is a right triangle.

4. The coupler of claim 1, wherein the mating pattern of the body resembles an undulating surface.

5. The coupler of claim 4, wherein the undulating surface is configured to mate with a corrugated pipe.

6. The coupler of claim 1, further comprising:
at least one seal.

7. The coupler of claim 6, wherein the at least one seal is an O-ring.

8. The coupler of claim 1, further comprising:
a retaining collar around the body.

9. A system comprising:
a body having a first mating surface;
a first piping extending through the body and having a second mating surface facing the first mating surface;
a retaining collar around the body;
a second piping having an end between the retaining collar and the body; and
at least one seal between the first piping and the second piping to create a water tight seal.

10. The system of claim 9, wherein an outside surface of the body has an engagement rib engaging the second piping.

11. The system of claim 10, wherein the body has a stop flange in contact with an end of the second piping.

12. The system of claim 9, wherein the first piping is a corrugated piping and the first mating surface is configured to mate with corrugations of the first piping.

13. The stem of claim 12, wherein the at least one seal resides is a valley of the corrugated piping.

14. The system of claim 13, wherein the at least one seal is a plurality of seals residing in a plurality of valleys of the corrugated piping.

15. The system of claim 9, wherein the retaining collar applies a compressive force to the second piping.
